(19) United States
(12) Patent Application Publication
(10) Pub. No.: US 2003/0083424 A1
(43) Pub. Date: May 1, 2003

(54) SPRAYABLE PLASTISOL COMPOSITION AND ITS USE FOR SOUND DAMPENING

(76) Inventors: EDWARD W. DUCK, BREMERVOERDE (DE); INGOLF SCHEFFLER, WIESLOCH (DE); KLAUS RUCH, WIESLOCH (DE)

Correspondence Address: STEPHEN D. HARPER, HENKEL CORPORATION, LAW DEPT., 2500 RENAISSANCE BLVD., SUITE 200, GULPH MILLS, PA, 19406, US

(21) Appl. No.: 08/458,628

(22) Filed: Jun. 2, 1995

Related U.S. Application Data
(63) Continuation of application No. 07/963,032, filed on Oct. 19, 1992, now abandoned.
Application No. 07/963,032 is a continuation of application No. 07/754,148, filed on Sep. 3, 1991, now abandoned.
Application No. 07/754,148 is a continuation of application No. 07/400,302, filed on Aug. 29, 1989, now abandoned.

(30) Foreign Application Priority Data
Sep. 7, 1988 (DE) P3830345.0

(51) Int. Cl. C08L 33/00

(52) U.S. Cl. 524/523

(57) ABSTRACT

A sprayable plastisol composition comprises 10 to 60% by weight of a polymer powder mixture having a particle size of less than 60 microns of a first polymer component and a second slightly cross-linked polymer component, whereby the first component forms the continuous phase after gelling of the plastisol and the second component is present as discontinuous phase dispersed therein, 15 to 65% by weight of a plasticiser which is compatible with the first polymer component but incompatible with the second polymer component, and 0 to 40% by weight of fillers. The composition is especially suitable for use in sound damping of sound emitting surfaces.

The invention relates to spayable plastisol compositions and their use for sound damping.

Very thin-walled metal sheets are almost exclusively used in the manufacture of vehicles, machines and appliances today. These thin-walled sheets are unavoidably set into vibration by mechanically moving parts or running motors and for this reason they emit sound. For the reduction of the sound emission these metal sheets are therefore provided, particularly in motor vehicle manufacture and in the manufacture of domestic appliances, with sound damping coatings, known as sound absorbing coatings.

In the conventional process mixtures of bitumen and fillers with a high specific weight are extruded into sheets, from which the appropriate shapes are punched or cut. These sheets are then bonded to the appropriate metal sheet parts and must sometimes also be adapted to the shape of the sheet by heating. Although these bitumen sheets are still frequently used because of their low material cost, they are very brittle and tend to peel off from the metal sheet particularly at low temperatures. Also incorporation of additives which has often been proposed only results in a slight improvement which is not sufficient for many applications. Moreover, it is completely impossible to apply the pre-formed bitumen parts to the complex-shaped or almost inaccessible metal sheet parts of machines or vehicles, e.g. the inner surfaces of the cavities of motor vehicle doors. In addition there is the further disadvantage that in many cases several punched parts are required for only one vehicle or appliance and therefore costly storage is required.

There has consequently been no lack of attempts to eliminate the disadvantages of bitumen sheets using other polymer systems. For example, aqueous polymer dispersions of polyvinylacetate or ethylene-vinylacetate copolymers containing fillers were developed which can be sprayed on to the metal sheet parts with the necessary coating thickness. These systems are, however, disadvantageous for industrial use when there are high rates of production because the water cannot be removed rapidly enough from the coating that is sprayed on, particularly when this coating is fairly thick.

The sound damping properties of polymer coatings are best in the range of the glass transition temperature of the polymer system, because due to the viscoelasticity of the polymer in this temperature range the mechanical energy of the vibration process is converted into heat by molecular flow phenomena. Conventional sprayable coating materials based on PVC plastisols, which e.g. are widely used as an underbody coating in motor vehicle construction, have no notable sound damping effect in the application temperature range of −20 to +60° C. because the maximum value of the glass transition is about −20° C. to −50° C. depending on the proportion of plasticiser.

Attempts were therefore made to modify these conventional PVC plastisols so that they would have better sound damping properties in the application temperature range of −20° C. to +60° C. Coatings are known from German published patent application 35 14 753 which contain multiple-unsaturated compounds, e.g. di- or triacrylate, peroxide cross-linking agents and inorganic fillers, in conventional PVC plastisols. In the hardened state these plastisols are, however, glass-hard and brittle, and are therefore not really suitable for use in automobile construction because they do not have sufficient flexibility particularly at low temperatures. Apart from this these formulations have a very low loss factor tan δ and thus the sound damping effect is not very marked.

Compositions are described in German published patent application 34 44 863 which contain PVC or vinylchloride/vinylacetate copolymers, optionally methylmethacrylate homopolymers or copolymers, a plasticiser mixture and inert fillers. The plasticiser mixture comprises plasticisers which are compatible with the methymethacrylate polymers and plasticisers for the vinylchloride polymers which are incompatible with the methacrylate polymers which may be present. The plastisols thus obtained have improved sound damping properties compared with conventional PVC plastisols. However, particularly at temperatures above about 30° C. the sound damping effect drops again. If an attempt is made to shift the range of the maximum loss factor tan δ to higher temperatures by varying the relative quantities of the individual components, the cold flexibility of the coating drops very severely. A reduced cold flexibility is, however, precisely what is disadvantageous in vehicle construction. In addition the loss factor decreases very severely at lower temperatures with these formulations. These plastisol compositions therefore have a sufficiently high loss factor only in a very narrow temperature range.

Accordingly the basic object of the invention is to provide a sprayable, storage-stable plastisol composition, with which coatings can be manufactured which have sound damping properties in the application temperature range of about −20 to about +60° C. Moreoever, the coatings obtained should show good cold flexibility and good resistance to abrasion so that they can also be used as an underbody coating having good sound damping properties.

This and other objects are achieved with a new sprayable plastisol composition comprising

a) 10 to 60 weight % of a polymer powder with an average particle size of less than 60 microns from a mixture of

i) a first polymer component, which forms the continuous phase after gelling of the plastisol, and

ii) a second slightly cross-linked polymer component which is only swollen after gelling of the plastisol and is present in dispersion in the continuous phase,

b) 15 to 65 weight % of plasticizer which gels the first polymer component at elevated temperature but only swells the second polymer component, and

c) 0 to 40 weight % of fillers.

The finely distributed swollen polymer phase, which is essentially responsible for the sound damping properties of the gelled coating, has one, or preferably more, glass transition temperatures in the range of −20 to +60° C. depending on its composition. On the other hand the continuous phase of the plasticized PVC network is essentially responsible for the mechanical properties, such as abrasion resistance, cold flexibility, hardness and adhesion to the substrate.

In a preferred embodiment the plastisol composition according to the invention comprises a vinylchloride homopolymer or a vinylchloride/vinylacetate copolymer as the first polymer component and as the second component a slightly cross-linked swellable polymer, which cannot be gelled with the plasticizer used, and a phthalate plasticizer as it is usually employed for PVC plastisols. In addition the composition can further comprise the usual fillers, rheology aids and adhesion promotors. The slightly cross-linked second polymer is present as a discontinuous, finely distributed, swollen phase in the gelled PVC network after the gelling process. The degree of swelling the discontinuous polymer phase experiences during the gelling of the continuous phase by the plasticizer can be controlled by the extent of the cross-linking and the co-monomer composition of the second polymer component. The plastisol compositions are preferably airless sprayable due to their low viscosity, and also have good storage stability at higher storage temperatures and are additionally free of volatile components. Using these compositions abrasion-resistant coatings can be manufactured which have sound damping properties in a wide temperature range and good cold flexibility.

For the continuous polymer phase dispersions of vinylchloride homopolymers or vinylchloride/vinylacetate copolymers in plasticizers are preferably used. Preferred plasticizers are phthalates such as dioctyl phthalate, dihexyl phthalate, diethylhexyl phthalate and benzylbutyl phthalate. In addition the phthalic acid esters of long-chain linear or branched alcohols or alcohol mixtures can be used. Other conventional plasticizers such as adipates and sebacates and phosphates, e.g. tricresyl phosphate, triphenyl phosphate and tributyl phosphate, can also be used. For selection it is essential that the plasticizer can gel the first polymer component at an elevated temperature under formation of a continuous phase, while it may only swell the second polymer component but not gel it, so that the latter remains dispersed in the continuous phase.

For the continuous polymer phase low viscous prepolymers with reactive groups are additionally suitable, which after the application by spraying harden either by air moisture or by heat into flexible elastomers. Examples of such prepolymers are single-component polyurethane prepolymers with reactive isocyanates as moisture hardening systems or single-component polyurethane prepolymers with blocked isocyanates as heat curing systems. As heat-reactive components highly flexible prepolymers with epoxy endgroups can also be used. The reactive polymers must occasionally be mixed with plasticizers, or so-called reactive thinners, so as to obtain a viscosity range suitable for spray application. What is understood by a “reactive thinner” is a compound which is difficult to volatilise and low in viscosity, and which can be introduced via a functional group in the polymer system without its flexibility being impaired. Examples of such reactive thinners are monofunctional epoxides, e.g. epoxidised a-olefins, allylglycidyl ethers, butylglycidyl ethers, epoxyvinyl cyclohexane and styrene oxides. These monofunctional epoxides are used predominantly for the reactive thinning of epoxy resins but they can also be used in polyurethane systems under suitable catalysis.

The preferred polymers forming the discontinuous finely dispersed polymer phase are slightly cross-linked homo- and copolymeric esters of methacrylic acid, particularly polymeric methyl- and/or butylmethacrylates, and slightly cross-linked polystyrene, slightly cross-linked copolymers of styrene with acrylonitrile, methylmethacrylate, acrylamide, methacrylamide, acrylic acid, methacrylic acid or α-methylstyrene and/or terpolymers consisting of styrene, acrylonitrile, butadiene and isoprene, respectively, or α-methylstyrene. Particularly suitable as cross-linking agents are divinyl benzene, butanediol dimethacrylate, triethyleneglycol dimethacrylate, unsaturated polyesters with low molecular weight and to a limited extent trimethacrylic acid esters of tri(hydroxymethyl)-propane. These slightly cross-linked polymers are manufactured in a manner known per se according to the techniques of emulsion polymerisation with the addition of peroxides or azo-compounds as initiators and converted in a subsequent spray-drying process into a finely divided polymer powder. According to the invention those polymer powders are suitable that have an average particle size of secondary agglomerates after the spray drying of <60 microns, and preferably of 10 to 35 microns.

In addition to the above-named polymers which are accessible through radical polymerisation, slightly cross-linked epoxidised natural rubber and other slightly cross-linked polymers are suitable as the second polymer component which forms the discontinuous phase, provided that the glass transition temperature(s) of the discontinuous swollen phase is (are) in the range of the desired application temperatures after gelling and hardening, respectively.

The extent of cross-linking, the comonomer composition and the type of the plasicizer used are usefully co-ordinated with each other, because these factors affect the degree of swelling of the dispersed polymer phase and therefore its glass transition temperature(s) and its acoustic loss factor tan δ. For methacrylate copolymers and styrene homo- or copolymers a proportion of 0.5 to 10 mole percent, and preferably 1 to 5 mole percent, of cross-linking agent in relation to the monomer mixture has proved suitable when phthalate plasticizers are used.

To select the suitable extent of cross-linking the powder of the weakly cross-linked polymer is dispersed in the plasticizer selected for the plastisol composition and heated to 50° C. While this is taking glace no gel formation should occur, but the viscosity of the composition should rise slightly due to the swelling of the polymer powder. The suitable extent of cross-linking for each plasticizer can easily be determined by this test.

The weight ration of the first polymer component which forms the continuous phase to the cross-linked second polymer component which forms the discontinuous phase can be varied in a wide range from 20:1 to 1:20, and preferably 15:5 to 5:15. The second polymer component which forms the discontinuous phase can, moreover, consist of a mixture of various weakly cross-linked copolymers. Such a mixture of different components makes it possible to achieve a high loss factor tan δ through a very wide temperature range.

In principle all the materials used in plastisol technology, e.g. crushed or precipitated chalk, barite, stone dust or carbon black, can be used as fillers which may optionally be present. Preferred are fillers with low specific weight which greatly increase the dynamic elasticity E′ of the composition without the loss factor tan δ being significantly lowered. By incorporating these into the plastisol compositions according to the invention the dynamic loss module E″, which is given by the equation E″=E′·tan δ is increased and gives a standard for the sound-damping effect of the coating. A preferred filler is finely dispersed vermiculite.

In the sprayable plastisol composition according to the invention the total polymer content is in the range of 10 to 60 weight %, and preferably 20 to 40 weight %, the plasticizer proportion is in the range of 15 to 65 weight % and preferably 25 to 45 weight %, and the filler proportion is in the range of 0 to 40 weight % and preferably 10 to 30 weight %. Moreoever, these mixtures can further contain adhesion promotors, rheology aids and other usual additives.

In order to achieve sound damping the two-phase polymer compositions according to the invention can in addition to the preferred application in the form of sprayable formulations also be used in the form of polymer mixtures which can be cast or doctored for coating, sealing or adhesion and as materials in the form of plates that are manufactured by the reaction injection-moulding process.

The gelling of the plastisol compositions according to the invention usually takes place at temperatures in the range of 80 to 230° C. after the composition has been sprayed on to the substrate to be treated, which is usually a metal or plastic surface.

The following examples serve to further illustrate the invention. Where not expressly otherwise stated the parts and percentages are parts and percentages by weight.

### EXAMPLE 1

Preparation of a Slightly Cross-Linked Homopolymer

27.3 parts of a seed latex with an average particle size of 0.075 microns and a solids content of 44% in a solution of 0.3 parts isoascorbic acid and 0.1 parts of sodium dodecyl sulphate were dispersed in 264 parts water in a face-grinding beaker with a horse-shoe mixer, two dropping funnels and a reflux condenser under a nitrogen atmosphere. This dispersion was heated to 70° C. and held at this temperature for the whole polymerisation.

A mixture of 485 parts styrene, 2.47 mole percent (in relation to the monomer mixture) of divinyl benzene and a solution of 3.7 parts sodium dodecylsulphate and 1 part isoascorbic acid in 190 parts water were added together dropwise over a period of 4 hours. Immediately after the start of the dropwise addition 1 part t-butylhydroperoxide was added to the reaction. An emulsion of 50 parts water, 0.1 parts sodium dodecyl sulphate and 0.6 parts t-butylhydroperoxide was prepared and added in three increments to the polymerisation mixture during the addition phase.

After the end of the addition a further 0.3 parts of t-butyl-hydroperoxide were added to the polymerization mixture, the dispersion was then held for another 2 hours at 70° C. and finally cooled with further stirring to ambient temperature. The dispersion had a solids content of 50%. For further use this dispersion was dried in a spray drier to a finely divided powder with an average particle diameter of 30 microns.

To test the stability in storage 50 parts of this powder were dispersed in 75 parts of dioctyl phthalate with a fast running dissolver and then heated to 60° C. for 30 minutes. The viscosity of the dispersion increased slightly due to the swelling of the polymer powder particles but it was still completely free-flowing, i.e. a very good storage stability is to be expected.

### EXAMPLE 2

Preparation of a Slightly Cross-Linked Copolymer

Using the same method as that described in Example 1 a mixture of 422 parts styrene, 50 parts acrylonitrile and 1.23 mole percent triethylenglycol dimethacrylate and 1.39 mole percent of divinyl benzene were polymerized and then spray-dried.

To test the storage stability this polymer was subjected to the same test as in Example 1; the viscosity increased more sharply but an adequate storage stability is to be expected.

### EXAMPLE 3

36 parts of an unsaturated polyester consisting of 43.1 parts propyleneglycol, 31.45 parts phthalic anhydride and 25.45 parts maleic anhydride with an average molecular weight of 1700 (GPC) were dissolved in 464 parts styrene and emulsion-polymerized as in Example 1 and then spray-dried. The storage stability test gave adequate results.

### EXAMPLE 4

434 parts styrene, 50 parts acrylonitrile and 2.4 mole percent divinyl benzene were emulsion polymerized as in Example 1 and then spray-dried. The storage stability test gave very good results.

### EXAMPLES 5 to 10

| Example | 5 | 6 | 7 | 8 | 9 | 10 |
|---|---|---|---|---|---|---|
| PVC | 25 | 25 | 25 | 25 | 25 | 25 |
| Polymer of Ex. 1 | 25 | — | — | — | — | 6.5 |
| Polymer of Ex. 2 | — | 25 | — | — | — | 6.5 |
| Polymer of Ex. 3 | — | — | 25 | — | — | 6.5 |
| Polymer of Ex. 4 | — | — | 25 | 25 | — | — |
| Vermiculite | — | — | — | 10 | — | 5 |
| ABS | — | — | — | — | — | 5 |
| DOP | 45 | 45 | 45 | 45 | 45 | 5.5 |
| tan δ (10 Hz) | | | | | | |
| Maximums at ° C. | −3 | −8.5 | −5 | −4 | −4 | −18 |
| | +67 | +51 | +45 | +61 | +58.5 | +38 |
| | | | | | | +80 |

PVC Paste type
DOP bis-(2-ethylhexyl)phthalate
ABS acrylonitrile-butadiene-styrene terpolymer with high butadiene content, melt index (ASTM D-1238): 0.4 g/10 min, Vicat solfetining point (ASTM D-1525): 102° C. at 1 kg weight
Vermicultie finely dispersed vermiculite - average particle size <15 microns

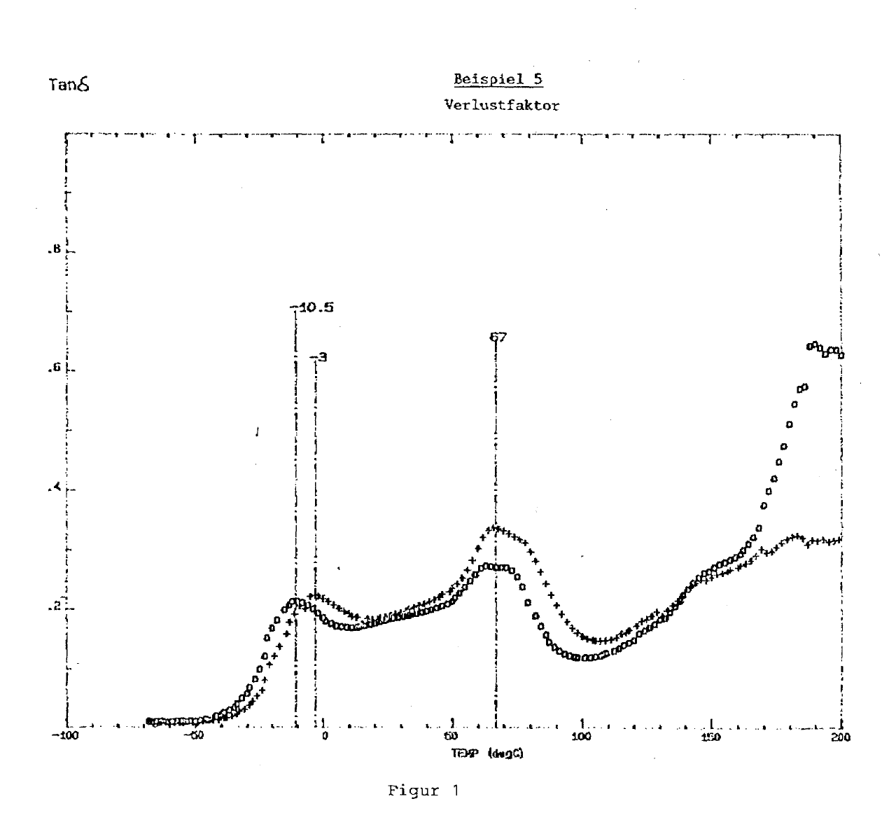

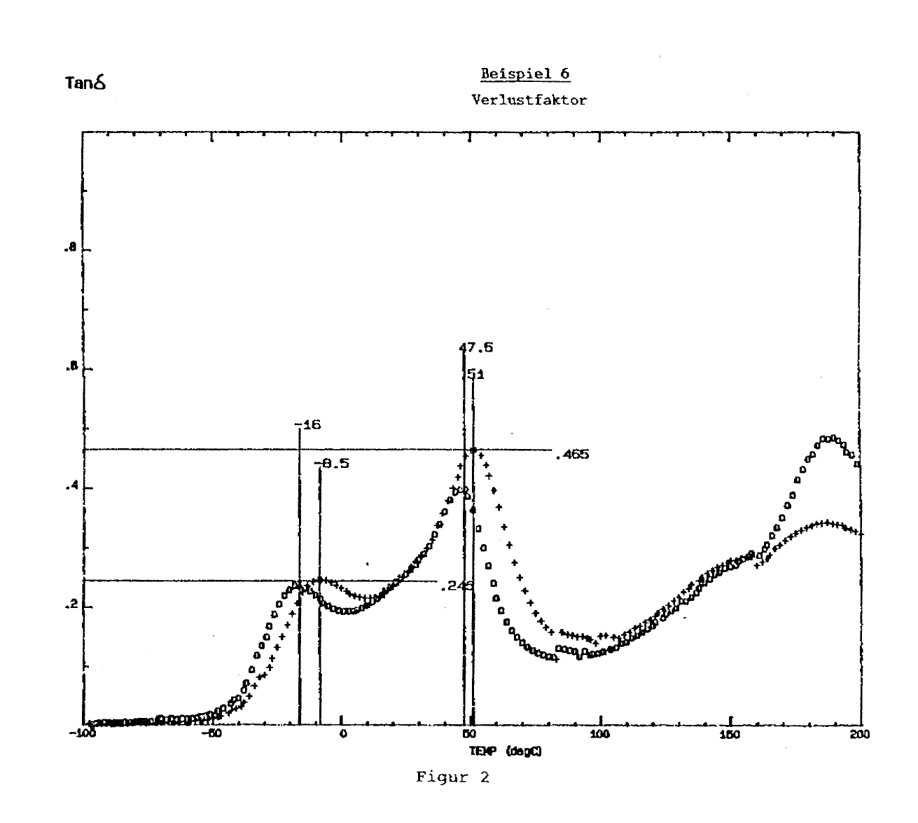

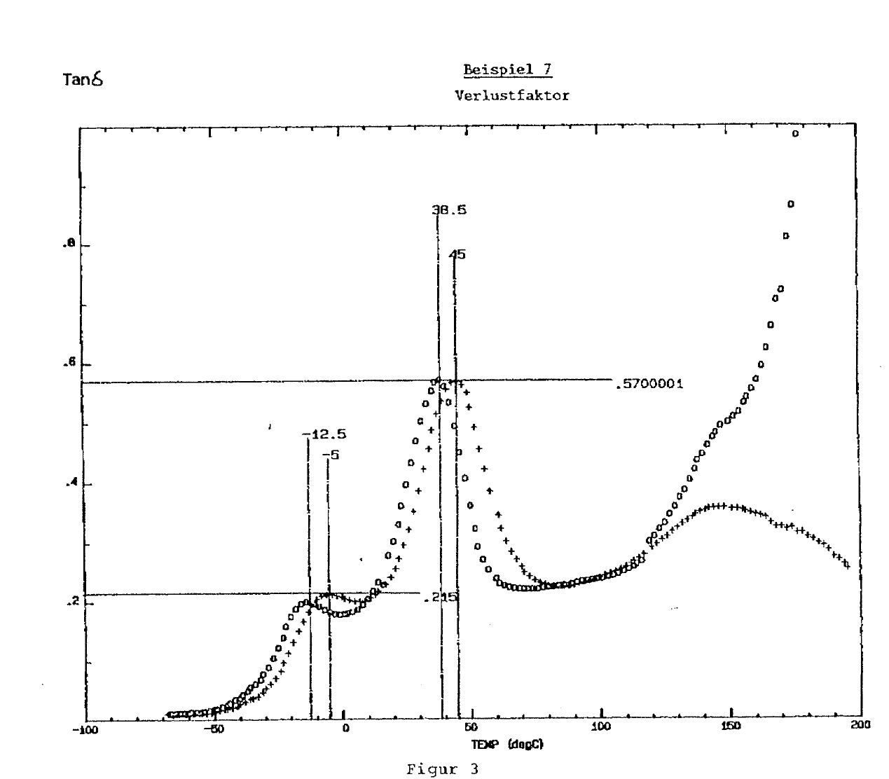

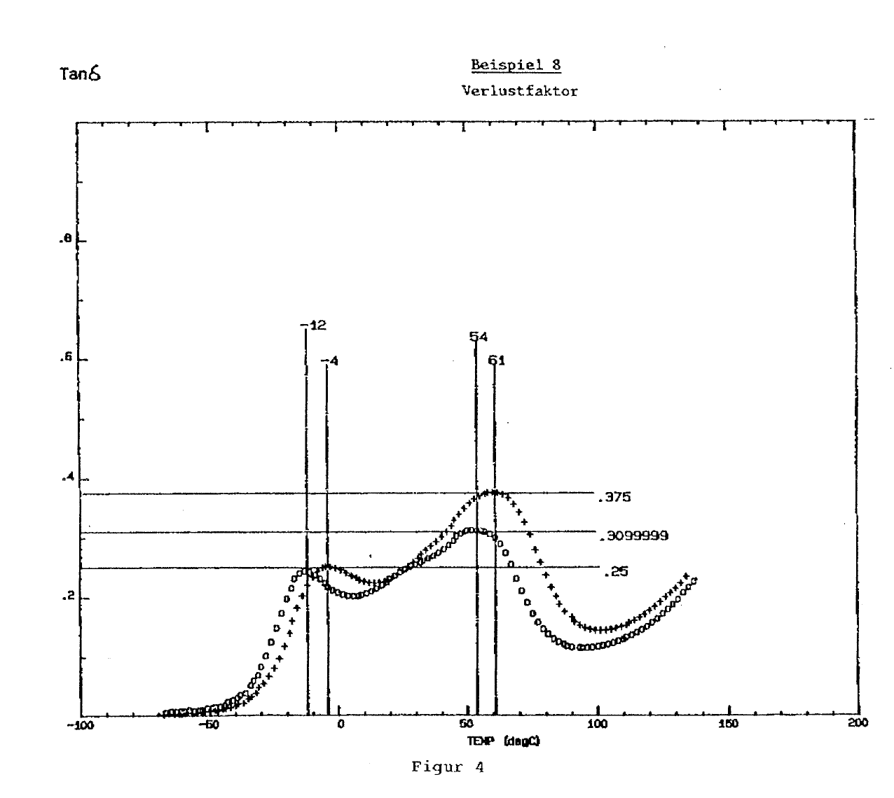

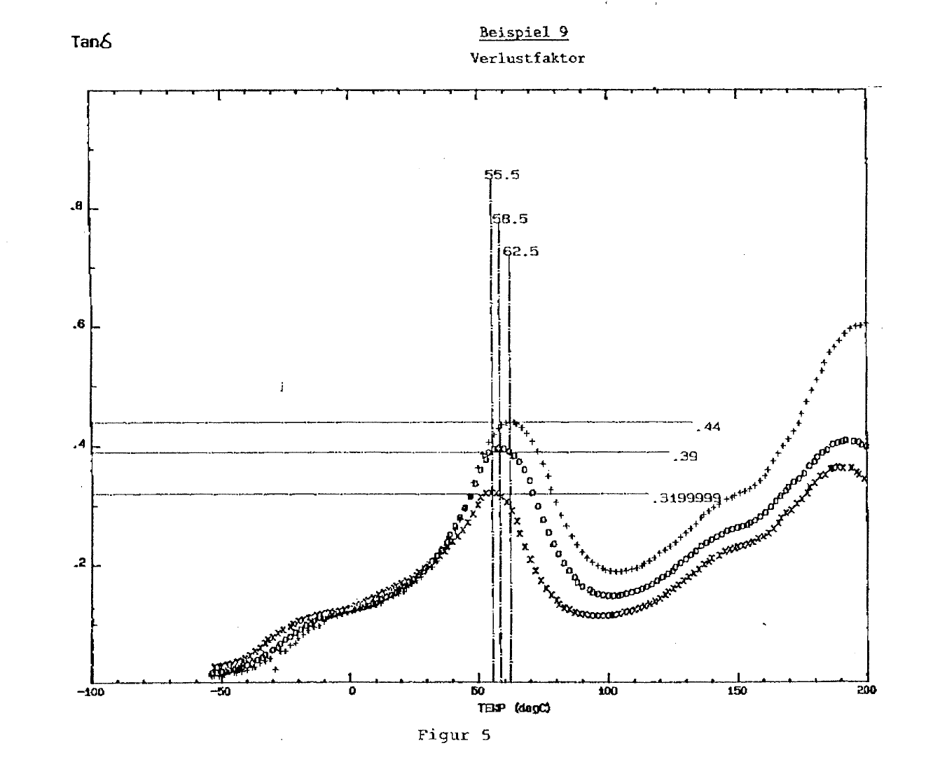

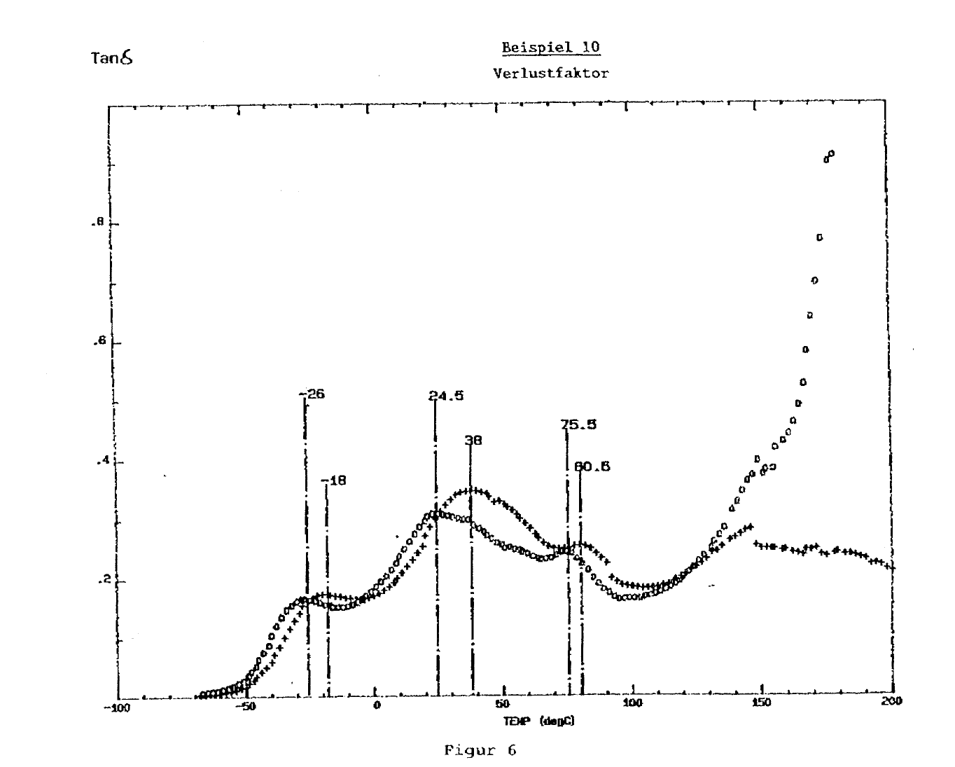

The plastisol formulations of Examples 5 to 10 were mixed with a dissolver, doctored to 3 mm thick layers and gelled for 300 minutes at 150° C. Then discs of 11 mm diameter were punched out and the loss factor was determined in a temperature range of −70 to +100° C. with a “Dynamic Mechanical Thermo Analyser” from the Polymer Laboratories Company in “Shear mode”. The temperature behavior is shown in FIGS. 1 to 6.

It is clear that the maximum value of the loss factor tan δ can be influenced over a wide temperature range, particularly by the appropriate admixture of several slightly cross-linked polymer powders as in Example 10.

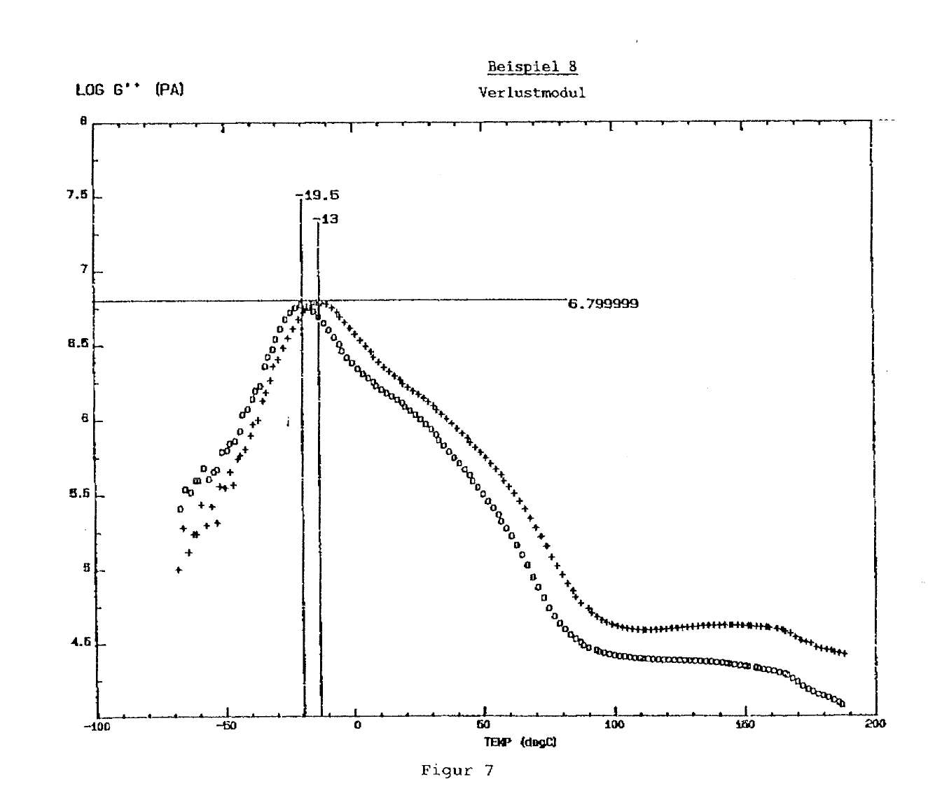

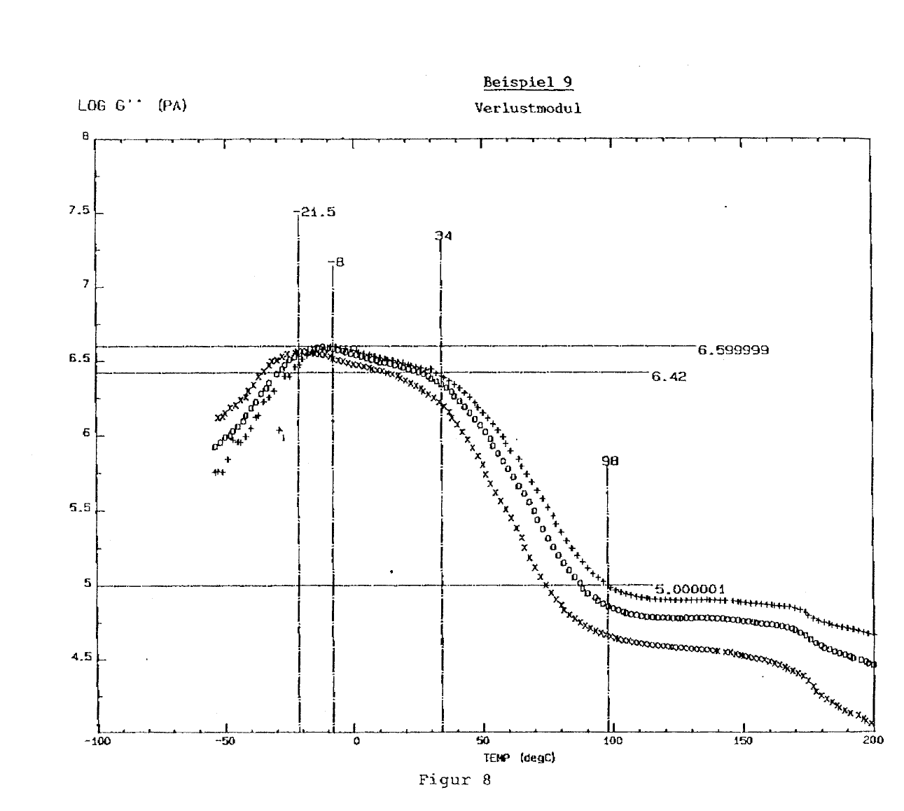

A comparison of Examples 8 and 9 shows that the temperature behavior of the loss module E″=E′·tan δ can be favorably affected by the addition of vermiculite as a filler. The range of temperature with a sufficiently high loss module has been significantly extended (FIGS. 7 and 8).

### COMPARATIVE EXAMPLE I

The following mixture was prepared with a dissolver:

22.5 parts PVC

47.5 parts bis-(2-ethylhexyl)-phthalate

30 parts trimethylolpropane trimethacrylate

1 part t-butyl hydroperoxide

20 parts mica

80 parts barite

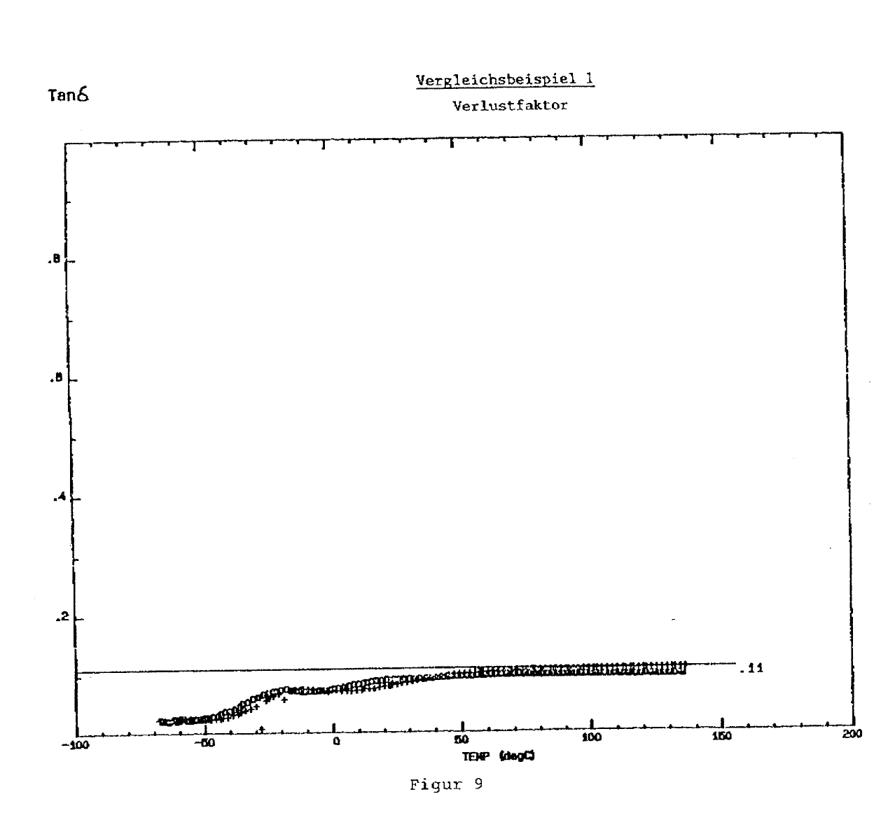

The mixture was doctored to a 3 mm thick layer and gelled for 30 minutes at 150° C. Discs of 11 mm diameter were then punched out of the hard and brittle material and measured with the “Dynamic Mechanical Thermo Analyser”. The tan δ curve (FIG. 9) shows only very low values of ≦0.1 in the whole temperature range.

### COMPARATIVE EXAMPLE 2

The following mixture was prepared using a dissolver:

50 parts PVC suspension copolymerisate with 12% vinylacetate, K value 60

15 parts MMA copolymer with 12% butylmethacrylate (paste type)

8 parts bis-(2-ethylhexyl)-phthalate

27 parts dibenzyl toluol.

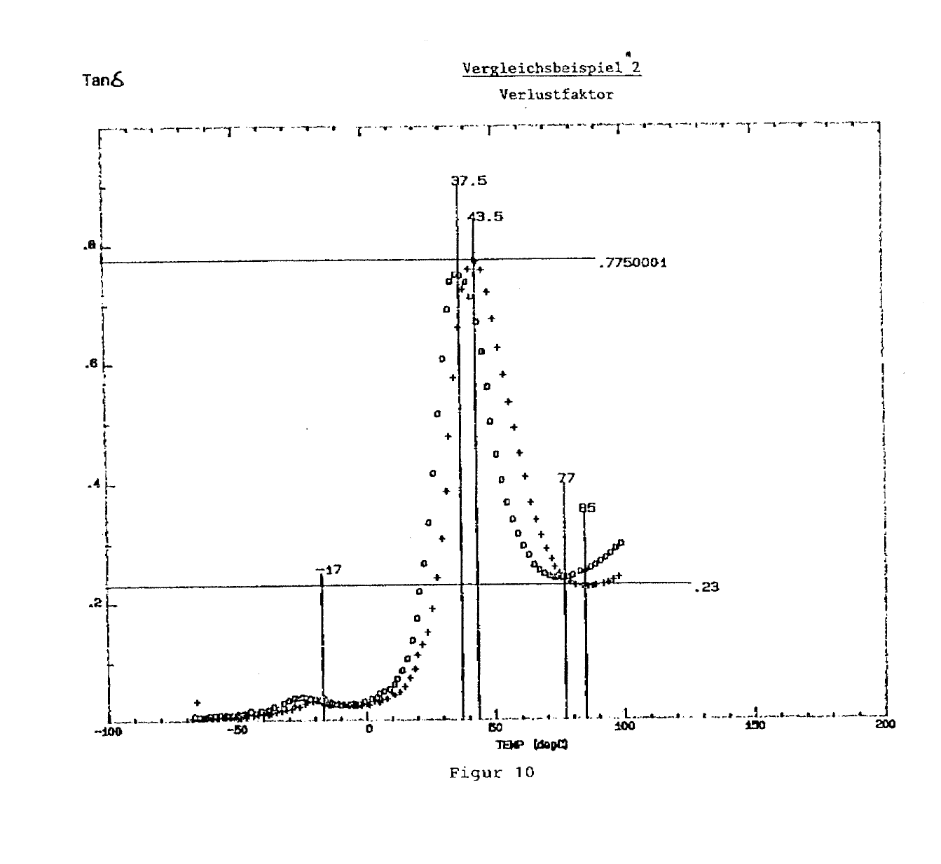

The mixture was doctored to a 3 mm thick layer and gelled for 30 minutes at 150° C. Discs of 11 mm diameter were then punched out and measured with the “Dynamic Mechanical Thermo Analyser”. The 10 Hz/tan δ curve (FIG. 10) shows a high maximum value at 43.5° C., which falls sharply at low temperatures.

The examples show clearly that it is possible according to the invention to formulate sprayable plastisols which have a high loss factor over a very wide temperature range and are therefore suitable for sound-damping coatings.

We claim:

1. A sprayable plastisol composition based on powders of organic polymers and plasticisers comprising
a) 10 to 60 weight percent of a polymer powder with an average particle size of less than 60 microns from a mixture of
i) a first polymer component, which forms the continuous phase after gelling of the plastisol, and
ii) a second slightly cross-linked polymer component which is only swollen after the gelling of the plastisol and is present as dispersion in the continuous phase,
b) 15 to 65 weight percent of plasticiser which gels the first polymer component at a higher temperature but only swells the second polymer component, and
c) 0 to 40 weight percent of fillers.

2. Plastisol composition according to claim 1, comprising as the first polymer component a vinylchloride homopolymer, a vinylchloride/vinylacetate copolymer, a mixture thereof.

3. Plastisol composition according to claim 1, comprising as the first polymer component low-viscous prepolymers with reactive groups which react under the effect of air moisture and/or heat.

4. Plastisol composition according to one of the claims 1 to 3, comprising as the second polymer component a slightly cross-linked swellable polymer, which after gelling has one or more glass transition temperatures in the range of −20 to +60° C.

5. Plastisol composition cording to one of the claims 1 to 3, comprising as the second polymer component slightly cross-linked homo- and/or copolymeric methyl- and/or butylmethacrylate.

6. Plastisol composition according to one of the claims 1 to 3, comprising organic phthalates as plasticisers.

7. Plastisol compositions according to one of the claims 1 to 3, comprising the first polymer component and the second polymer component in a weight ratio of 20:1 to 1:20.

8. A process for the sound damping of sound emitting surfaces by applying a sprayable plastisol composition based on powders of organic polymer and plasticisers comprising
a) 10 to 60 weight percent of a polymer powder with an average particle size of less than 60 microns from a mixture of
i) a first polymer component, which forms the continuous phase after gelling of the plastisol, and
ii) a second slightly cross-linked polymer component which is only swollen after the gelling of the plastisol and is present as dispersion in the continuous phase,
b) 15 to 65 weight percent of plasticiser which gels the first polymer component at a higher temperature but only swells the second polymer component, and
c) 0 to 40 weight percent of fillers
to the surfaces and then gelling the plastisol composition.
